(19) United States
(12) Patent Application Publication
(10) Pub. No.: US 2024/0199385 A1
(43) Pub. Date: Jun. 20, 2024

(54) CANTILEVER HOIST DEVICE

(71) Applicant: BINAR HANDLING AB, TROLLHATTAN (SE)

(72) Inventor: Niclas Johansson, TROLLHATTAN (SE)

(73) Assignee: BINAR HANDLING AB, TROLLHATTAN (SE)

(21) Appl. No.: 18/556,398

(22) PCT Filed: Apr. 4, 2022
(86) PCT No.: PCT/EP2022/058891

§ 371 Date: Oct. 20, 2023

(30) Foreign Application Priority Data
Apr. 23, 2021 (SE) 2150522-7

(51) Int. Cl. B66C 23/20

(52) U.S. Cl. CPC B66C 23/202; B66C 23/201; B66C 2700/018; B66C 2700/0385

(57) ABSTRACT

A cantilever hoist device lifts a load in a spatially limited environment includes a support column having a proximal end and a distal end), wherein the proximal end secures the support column in an upright position. Moreover, the device includes an elongated, stiff, and rigid cantilever arm hingedly mounted at the distal end. Additionally, the device includes a drive unit arranged to displace the load towards or away from the cantilever arm using a lifting medium passing one or more pulleys. The drive unit includes a winding body onto which the lifting medium is rollable to displace the load. The drive unit is mounted at the distal end of the support column.

### TECHNICAL FIELD

Embodiments herein relate to low-cost lifting arrangements, such as cantilever hoist devices, small swing arm cranes, for use in indoor environments. In particular, a cantilever hoist device adapted for lifting a load in an indoors environment is disclosed.

### BACKGROUND

Low-cost lifting arrangements, sometimes referred to as jib cranes, swing arms cranes, cantilever hoist cranes or the like, typically have in common that a load is liftable upwards or downwards from a lever arm from which the load hangs in e.g. a wire rope. The lever arm is straight and without joints or telescopic lengthening capabilities. The lifting of the load is achieved by that a motor rotates a drum to wind or unwind the wire rope to/from the drum. In this manner, these types of cranes include a reduced number of moving parts as compared to other more advanced and expensive cranes that have lifting arms with one or more joints or telescopic capabilities, thereby creating savings on both bill of material and cost of operation due to less maintenance.

A particular type of these low-cost lifting arrangements are adapted for indoor environments. This means that the lifting arrangement is limited in height and horizontal extension to be able to fit within e.g. a building, such as house, a warehouse, a storage building or the like.

A typical known low-cost lifting arrangement comprises a vertical support pilar at which a lever arm is turnably connected, e.g. by means of a joint. Thanks to the joint the lever arm can be turned in a horizontal plane e.g. within a range from 0 to 270 degrees or somewhat more. A lifting unit, including a motor, a wire rope or a chain, for lifting or lowering a load, is attached to the lever arm. To reach different positions the lifting unit is typically movable along the lever arm and the lever arm can be turned. While this lifting arrangement may be well suited for certain applications, a disadvantage may be that maneuverability may not be sufficient in some applications, especially when it is desired to move loads quickly.

### SUMMARY

An object may be to eliminate, or at least reduce, the abovementioned disadvantage.

According to an aspect, there is provided a cantilever hoist device adapted for lifting a load in a spatially limited environment. The cantilever hoist device comprises a support column having a proximal end and a distal end. The proximal end is adapted to secure the support column in an upright position.

Moreover, the cantilever hoist device comprises an elongated, stiff, and rigid cantilever arm hingedly mounted at the distal end.

Furthermore, the cantilever hoist device comprises a drive unit arranged to displace the load towards or away, e.g. upwards or downwards, from the cantilever arm using a lifting medium passing one or more pulleys. The drive unit comprises a winding body onto which the lifting medium is rollable to displace the load and the drive unit is mounted at the distal end of the support column.

Due to that the cantilever arm is hingedly mounted at the distal end of the support column, the cantilever arm is rotatable around a rotational axis. In addition, the drive unit is mounted at the support column, which thus is separate from the cantilever arm, and the drive unit is stationary when the cantilever arm is rotated. In this manner, moment of inertia when the cantilever arm is rotated about the rotational axis is reduced compared to known low-cost lifting arrangements with stiff and rigid cantilever arms. As a result, the cantilever hoist device enables improved maneuverability, e.g. in terms of acceleration in at least one of the radial and tangential directions with respect to the rotational axis.

In some embodiments, a portion of a path along which the lifting medium runs is coincidental with the rotational axis of the cantilever arm. In this manner, the lifting medium is smoothly conveyed to or from the winding body of the drive unit when the load is lifted or lowered. The rotational axis is typically parallel with the support column.

In some embodiments, the lifting medium comprises one or more of a wire rope, a rope, a chain, a fiber, and a string.

In some embodiments, displacement of the load along the cantilever arm 120 is solely provided by manual operation. Thus, an overall construction of the cantilever hoist device is provided at a low-cost and reduces maintenance to maintain proper operation.

### BRIEF DESCRIPTION OF THE DRAWINGS

The various aspects of embodiments disclosed herein, including particular features and advantages thereof, will be readily understood from the following detailed description and the accompanying drawings, which are briefly described in the following.

FIG. 1a and FIG. 1b are schematic overviews of exemplifying cantilever hoist devices according to some embodiments herein.

FIG. 2 is a cross-sectional along line AB in FIG. 1a or FIG. 1b to illustrate details of the exemplifying cantilever hoist device according to some embodiments herein.

FIG. 3a and FIG. 3b illustrate details of an exemplifying cantilever hoist device.

FIG. 4 to FIG. 6 are side views illustrating exemplifying embodiments of the cantilever hoist device.

### DETAILED DESCRIPTION

Throughout the following description, similar reference numerals have been used to denote similar features, such as devices, actions, modules, circuits, parts, items, elements, units or the like, when applicable.

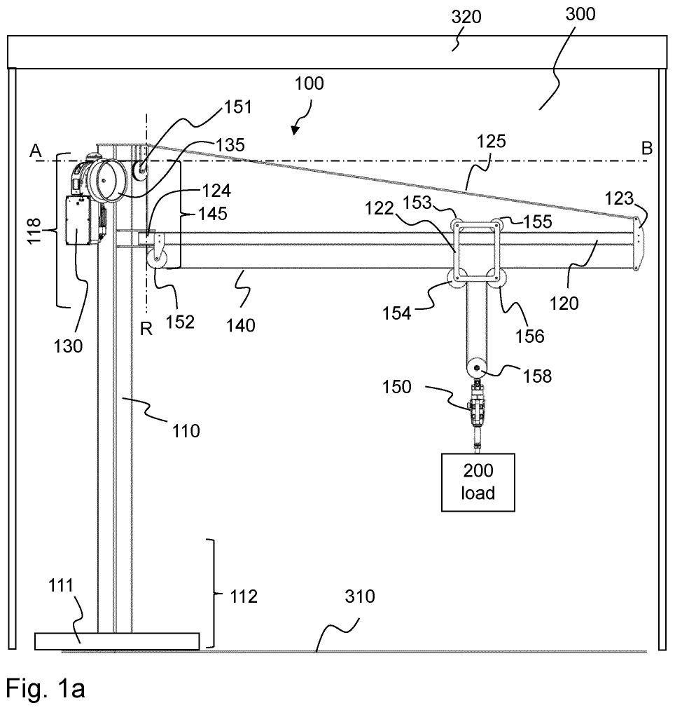

FIG. 1a depicts an exemplifying cantilever hoist device 100 according to some embodiments herein. In this example, the cantilever hoist device 100 may be a swing crane, a jib crane, a cantilever hoist crane or the like for use in a spatially limited environment 300, such as an indoors environment, a warehouse, a barrack, a storage with or without walls, completely or semi-covered with a roof or overleaf frame structures 320 or the like. Further, the spatially limited environment 300 may be a spatially limited outdoors environment of any kind. The outdoor environment 300 may similarly have or not have walls, be completely or semi-covered with a roof or overleaf frame structure 320 or the like. For example, it may be a storage area for various articles and items that may be stored in such outdoors environment.

The cantilever hoist device 100 is adapted for lifting a load 200 in the spatially limited environment 300. In particular, the cantilever hoist device 100 may be configured to operate, e.g. for purposes of lifting or lowering only, on the load 200 having a weight in a range of 0-300 kg, more preferably 0-200 kg, and most preferably 0-100 kg.

The cantilever hoist device 100 comprises a support column 110. A length of the support column 110 is typically less than 5 m, preferably in a range of 2 to 5 m and most preferably in a range of 1 to 3 m. A typical length of the support column 110 may be about 3 m. As a non-limiting example, the support column 110 may have a square cross-section, whose side is in the range of 80-220 mm, more preferably 100-160 mm, and most preferably 120-150 mm. Further, as a non-limiting example, the support column 110 may be made of steel, or other suitable material.

The support column 110 has a proximal end 112 and a distal end 118. The proximal end 112 is adapted to secure the support column 110 in an upright position, such as in a vertical position, or substantially vertical position.

The support column 110 may include a securing base 111, typically at the proximal end 112 of the support column 110. The securing base 111 may be a metal plate with holes through which bolts, nails or the like, are insertable and screwable into a floor 310, a ground 310, the overleaf frame structure 320 or the like. Moreover, in case the cantilever hoist device 100 rest on the floor or ground, the securing base 111 may be counter-weight base having a weight that is sufficient to allow the support column 110 to rigidly stand on the floor 310 or ground 310.

In one example, the proximal end 112 is adapted to securely fasten the support column 110 on a floor 310 of an indoors environment, whereby the support column 110 is up-rightly mountable on the floor 310. As an example, the support column 110 is mountable vertically at the floor 310.

In another example, as shown in FIG. 1b, the proximal end 112 is adapted to securely fasten the support column 110 at the overleaf frame structure 320, whereby the support column 110 is up-rightly mountable at the overleaf frame structure 320.

The cantilever hoist device 100 further comprises an elongated, stiff, and rigid cantilever arm 120 hingedly mounted at the distal end 118. As an example, the cantilever arm 120 may be hingedly mounted by means of a joint 124 or the like. The cantilever arm 120 may be a beam arm, a lever arm, a swing arm or the like.

The cantilever arm 120 may typically be rotatable in a range from 0 to 320 degrees, more preferably from 0 to 300 degrees and most preferably from 0 to 270 degrees. Furthermore, the cantilever arm 120 has a longitudinal length of less than 5 m, preferably less than 4 m and most preferably less than 3.5 m or a length of about 3.5 m.

In order to facilitate, e.g. reduce stress, the hinged mounting of the cantilever arm 120 at the distal end of the support column 110, a wire rope 125 may be provided. The wire rope 125, or other offloading element, is provided to off-load e.g. the joint, or hinge, at the distal end of the support column 110. As a result, dimension of the cantilever arm 120 may be less than without the wire rope 125. As an example, the cantilever arm 120 may have a rectangular cross-section, such as 40×60 mm or the like. The high of the cantilever arm 120 is preferably greater than the width, in order to take advantage of better strength when thus mounted. The width of the cantilever arm 120 may be in a range of 20-60 mm and the height of the cantilever arm 120 may be in a range of 40-80 mm. Other widths and heights of the cantilever arm 120 may also be used depending on application. Sometimes, the cantilever arm 120 may have a circular cross-section, whose diameter may be e.g. 30-80 mm or the like. Typically, the diameter may be 50 mm. Further, as an example, the cantilever arm 120 may be made of aluminum, steel, composite material, or the like.

Moreover, the cantilever hoist device 100 comprises a drive unit 130 arranged to displace the load towards or away from the cantilever arm 120 using a lifting medium 140 passing one or more pulleys 151, 152, 154, 156, 158, such as one or more blocks or the like. The drive unit 130 may comprise a motor, an electric motor, a combustion engine, a pneumatic motor, hydraulic motor or the like.

The lifting medium 140 may comprise one or more of a wire rope, a chain, a fiber, a line, a cable, a belt, a string, a rope and the like. Typically, the lifting medium 140 is non-extendable, or substantially non-extendable, in the longitudinal direction thereof.

The drive unit 130 comprises a winding body 135 onto which the lifting medium 140 is rollable to displace the load 200. Accordingly, the drive unit 130 is adapted to roll the lifting medium onto or off the winding body 135. The winding body 135 have a cylindrical surface with a circular or oval cross-section perpendicularly to the rotational axis (not illustrated) of the winding body 135. The winding body 135 may have other shapes suitable for winding of the lifting medium 140.

A distal end of the lifting medium 140 is fixed at a distal end of the cantilever arm 120. Preferably, the lifting medium 140 is fixed at a crossbar 123, e.g. at a lower end of the crossbar 123. Thereby, the lifting medium's 140 path arrives at the crossbar at a distance from the cantilever arm 120. The crossbar 123 is located, such as fixed, integrated with, mounted at or the like, at the distal end of the cantilever arm 120. The crossbar 123 may extend longitudinally, e.g. in the same or substantially the same direction as the support column 110.

A proximal end of the lifting medium 140 may be fixed at the winding body 135, whereby the lifting medium is rollable onto and off the winding body 135 as the winding body 135 rotates. The drive unit 130 may of course include a gear box and/or other part as well. As an example, the drive unit 130 has a power of less than 1500 W, preferably less than 1000 W.

Moreover, the wire rope 125 may be fixed at the crossbar 123, e.g. at an upper end of the crossbar 123. Thereby, the wire rope 125 arrives at the crossbar at a distance from the cantilever arm 120.

The drive unit 130 is mounted at the support column 110, typically at the distal end 118 of the support column 110. In this manner, it is achieved that the drive unit 130 remains stationary, i.e. the drive unit 130 does not rotate, or more, together with the cantilever arm 120 when the cantilever arm 120 is rotated. Consequently, when the load is moved in a tangential direction, or circularly, with respect to a rotational axis R the weight of the drive unit 130 does not contribute to moment of inertia caused by the movement. Thus, the load may more easily be moved quickly from one position above the floor 310 to another position above the floor 310. In more detail, at a given force and a given load, the load can be operated, radially and/or tangentially by manual labor, with higher accelerations when using the cantilever hoist device according to the embodiments herein as compared to known cranes of the same type and in the same price range.

Torque may also be referred to as the moment, moment of force, rotational force or turning effect, depending on the field of study.

An advantage may therefore be that the cantilever hoist device may be operated, such as maneuvered, quickly at ease. In turn, due to time savings, there may also be cost savings.

Thanks to the embodiments herein, there is provided an advantageous low-cost, cantilever hoist crane for use in the spatially limited environment with lower moment of inertia than existing cranes of the same type and in the same price-range.

In view of the above, it may be noted that the spatially limited environment 300 may impose one or more of the following aforementioned constraints to the cantilever hoist device 100.
A length of the support column 110 is typically less than 5 m, preferably in a range of 2 to 5 m and most preferably in a range of 1 to 3 m. A typical length of the support column 110 may be about 3 m.
The cantilever arm 120 has a longitudinal length of less than 5 m, preferably less than 4 m and most preferably less than 3.5 m or a length of about 3.5 m.
The drive unit 130 has a power of less than 1500 W, preferably less than 1000 W.
The cantilever hoist device 100 may be configured to operate, e.g. for purposes of lifting or lowering only, on the load 200 having a weight in a range of 0-300 kg, more preferably 0-200 kg, and most preferably 0-100 kg.

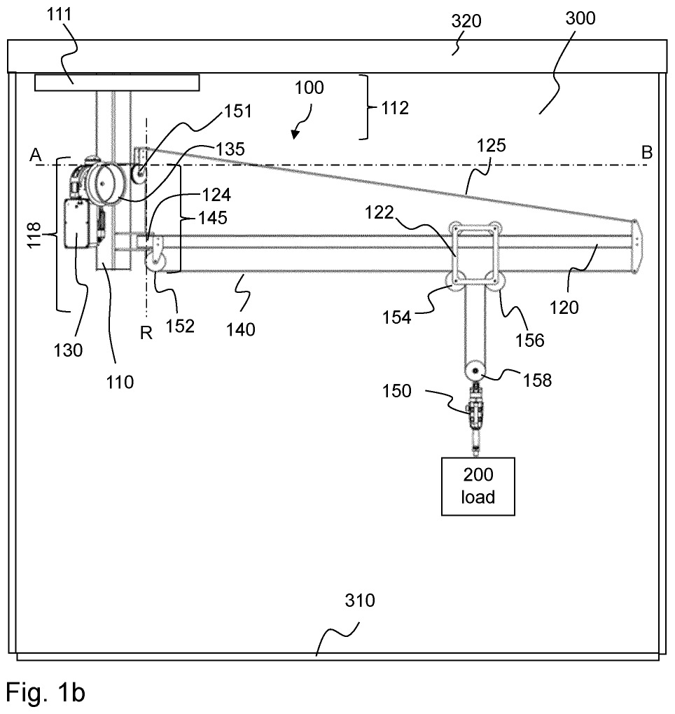

In some embodiments, a portion 145 of a path along which the lifting medium 140 runs, e.g. when lifting or lowering the load 200, is coincidental with the rotational axis R of the cantilever arm 120. As an example, the path runs coincidentally with the rotational axis R in that the path runs along and parallelly with the rotational axis in a same and common axis, i.e. the rotational axis R. In FIG. 2, the portion 145 is illustrated as a small dot on the axis R, that runs perpendicularly to a plane of the paper. This is advantageous, because a force, e.g. due to the load 200, is directed at the axis R, i.e. the rotational axis of the cantilever arm 120. In this manner, the force causes, via the pulleys and lifting medium, essentially no torque, or very little torque. As a result, any stress, such as torque, caused by the cantilever arm 120 is independent, or at least substantially independent, of an angle of rotation about the rotational axis R.

A varying torque caused to the cantilever arm is preferably avoided since, that torque typically causes the cantilever arm to swing, or rotate, about the rotational axis R. Thereby, disadvantageously moving, or rotating, the cantilever arm 120 away from an assumed operating position. Accordingly, when the path 145 along which the lifting medium runs is coincidental with the rotational axis R, such toque is eliminated, almost eliminated, or at least reduced.

A length of the portion may preferably be in a range of 10-70 cm, more preferably in a range of 20-60 cm, and most preferably in a range of 30-50 cm.

Other portions of the path may e.g. run parallelly with the cantilever arm 120. The other portions may be between a trolley (see below) and the distal end of the cantilever arm 120 and/or between the trolley and a proximal end of the cantilever arm 120.

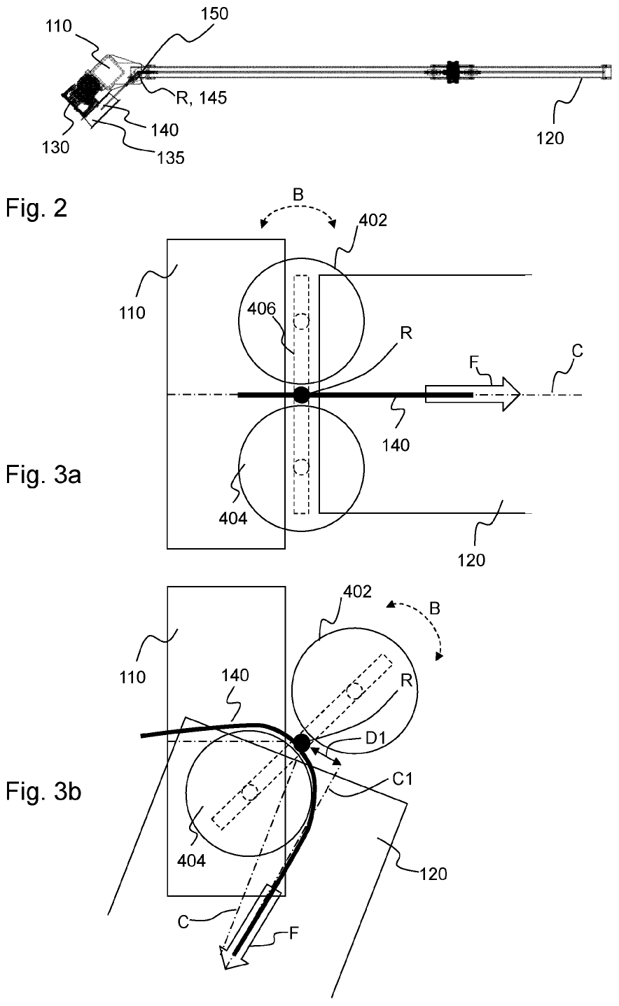

As an alternative, illustrated in FIG. 3a and FIG. 3b, a pair of blocks 402, 404 may be mounted at the proximal end of the cantilever arm 120. The pair of blocks 402, 404 may be a pulley with two wheels adapted to convey and feed the lifting medium 140. In FIG. 3a and FIG. 3b, for example, the joint 124, the drive unit 130 etc. have been left out for simplicity of the drawings. Each block 402, 404 has a respective rotational axis that runs parallelly with the rotational axis R, illustrated by dotted circles. A distance between the circumferences of the blocks is adapted to accommodate the lifting medium 140. In this fashion, an increased or varying torque may be caused by the lifting medium, the load and the pulleys as the cantilever arm 120 deviates from a starting position, or neutral position, shown in FIG. 3a. In the neutral position, none or very little torque is caused to the cantilever arm 120 since the force F is directed at the axis R. A central longitudinal axis C of the cantilever arm 120 is illustrated as a reference. When deviating from the starting position, as illustrated in FIG. 3b, an angle of rotation about the rotational axis R increases. The lifting medium 140 still runs through the rotational axis R, but due to the pulleys 402, 404 the force F is directed at a point, located at a distance D1 from the axis R. Since this distance D1 varies with rotation of the cantilever arm 120, the torque varies with different positions of the cantilever arm 120. In more detail, the force's F direction C1 does not coincide with the central longitudinal axis C as soon as the cantilever arm 120 deviates, or at least deviates sufficiently much, from the starting position of FIG. 3a.

In the aforementioned embodiments, in which the portion 145 of the path along which the lifting medium 140 runs is coincidental with the rotational axis R, consistent maneuverability over the entire range of operation may be achieved, e.g. over the entire range of rotation of the cantilever arm 120.

In order to keep cost of the cantilever hoist device 100 low, displacement of the load 200 along the cantilever arm 120 is solely provided by manual operation. This may e.g. be achieved by that the lifting medium 140 passes one or more pulleys, in more detail a first block 154 and a second block 156. The first and second blocks 154, 156 may be mounted on a trolley 122. The trolley 122 is slidable along the longitudinal length of the cantilever arm 120. Accordingly, the trolley 122 and/or the load 200 may only be manually displaced in the radial direction with respect to the rotational axis R.

The trolley 122 may be a frame structure, e.g. in the form of one or more rectangular frames or the like. Pulleys, or blocks, 153, 155 may be arranged to roll along an upper surface of the cantilever arm 120. In this manner, the trolley 122 may be conveyed along the cantilever arm 120. The pulleys 153, 155 of the trolley 122 may be located at a respective corner of the trolley 122.

By means of the first and second blocks 154, 156, a further adjustable portion of the path runs vertically away from the cantilever arm 120 and back, possibly via a third block 158. In this manner, the load 200 can be lifted upwards or lowered downwards. The first and second blocks 154, 156 of the trolley 122 may be located at a respective lower corner of the trolley 122. It may be preferred that the diameter of the pulleys 153, 155 is less than the diameter of the first and second blocks 154, 156.

At a lower end of the further adjustable portion, the load 200 may be hung, e.g. onto the block 158. In some examples, the load 200 may be carried by the cantilever hoist device 100 via a load carrying and/or attaching device 150 that may be attachable to the block 158. Moreover, in some examples, the load carrying and attaching device 150 may include an operation handle for controlling the drive unit 130, and thus the lifting of the load 200. By means of the operation handle the drive unit 130 may be run forwards or backwards to wind the lifting medium onto or off the winding body 135, whereby the load 200 is lifted or lowered, respectively. When a user (not shown) operates or maneuvers the load 200, the user may pull or push the load 200 using the load carrying and/or attaching device 150. Although not shown, the operation handle may be connected to the drive unit 130 by means of an electrical cable, a data bus or the like. In this context, it may be noted that further portions of the path of the lifting medium run perpendicularly to the cantilever arm 120 to reach the load carrying and attaching device 150.

Moreover, also in order to keep cost of the cantilever hoist device 100 low, displacement of the load 200 in a tangential direction, or rotation, about the rotational axis R is solely provided by manual operation.

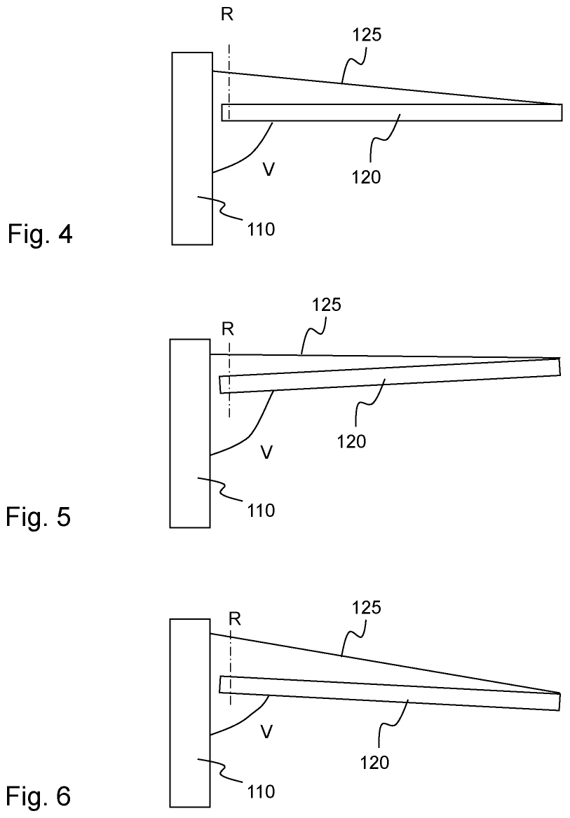

In some embodiments, see FIG. 4 to FIG. 6, the cantilever arm 120 may be hingedly mounted at the distal end 118 of the support column 110, wherein an angle V between the support column 110 and the cantilever arm 120 is in a range from 87 degrees to 93 degrees, preferably 88-92 degrees, and most preferably 89-91 degrees.

As an example, referring to FIG. 4, the angle V may be 90 degrees, or approximately 90 degrees. The load 200 and/or the load carrying and/or attaching device 150 may then be equally easily maneuverable towards and away from the support column 110.

As an example, referring to FIG. 5, the angle V may be in a range of 91-93 degrees. The load 200 and/or the load carrying and/or attaching device 150 may then be biased to be more easily maneuverable towards the support column 110.

As an example, referring to FIG. 6, the angle V may be in a range of 87-89 degrees. The load 200 and/or the load carrying and/or attaching device 150 may then be biased to be more easily maneuverable away from the support column 110.

Moreover, the angle for achieving biasing may be fixed or manually adjustable, e.g. by an operator of the cantilever hoist device 100. With a manually adjustable angle, the cantilever hoist device 110 is allowed to be adapted to various use cases in a flexible manner. The fixed angle provides for a more cost-efficient solution as compared to having an adjustable angle.

Even though embodiments of the various aspects have been described, many different alterations, modifications and the like thereof will become apparent for those skilled in the art. The described embodiments are therefore not intended to limit the scope of the present disclosure.

1. A cantilever hoist device adapted for lifting a load in a spatially limited environment, comprising:
a support column having a proximal end and a distal end, wherein the proximal end is adapted to secure the support column in an upright position,
an elongated, stiff, and rigid cantilever arm (120) hingedly mounted at the distal end, wherein the cantilever arm is rotatable around a rotational axis that is parallel with the support column,
a drive unit arranged to displace the load towards or away from the cantilever arm using a lifting medium (140) passing one or more pulleys, wherein the drive unit comprises a winding body onto which the lifting medium is rollable to displace the load,
wherein the drive unit is mounted at the distal end of the support column.

2. The cantilever hoist device according to claim 1, wherein a portion of a path along which the lifting medium runs is coincidental with a rotational axis of the cantilever arm.

3. The cantilever hoist device according to claim 1, wherein the lifting medium comprises one or more of a wire rope, a chain, a fiber, a cable, a belt, a rope and a string.

4. The cantilever hoist device according to claim 1, wherein displacement of the load along the cantilever arm is solely provided by manual operation.

5. The cantilever hoist device according to claim 1, wherein a length of the support column is less than 5 m.

6. The cantilever hoist device according to claim 1, wherein the cantilever arm has a longitudinal length of less than 5 m.

7. The cantilever hoist device according to claim 1, wherein the drive unit has a power of less than 1500 W.

8. The cantilever hoist device according to claim 1, wherein the drive unit (130) is configured to operate on loads, such as the load, having a weight in a range of 0-300 kg.
